(19) United States
(12) Patent Application Publication
(10) Pub. No.: US 2006/0159989 A1
(43) Pub. Date: Jul. 20, 2006

(54) System and process for forming battery cans

(75) Inventor: Richard Bouffard, Litchfield, CT (US)

Correspondence Address: Attn: Arthur G. Schaier;Carmody & Torrance LLP, 50 Leavenworth Street, P.O. Box 1110, Waterbury, CT, 06721-1110, US

(73) Assignee: Truelove & Maclean, Inc., Waterbury, CT (US)

(21) Appl. No.: 11/039,424

(22) Filed: Jan. 19, 2005

(51) Int. Cl. H01M 2/02; B21C 23/00; B21D 11/10

(52) U.S. Cl. 429/164; 72/256; 72/379.4

(57) ABSTRACT

A process for producing a battery can in a transfer press comprises drawing a metal cup in a first station to form an elongated cylinder, ironing the elongated cylinder in a second station, and redrawing the elongated cylinder in a third station. In either or both the drawing and ironing steps, the cup or the elongated cylinder may be processed in more than one station. The process includes a final redraw station for redrawing the cylinder so as to roughen the inner surface of the battery can to improve its electrical properties.

### TECHNICAL FIELD

This invention relates in general to battery cans, and, more particularly, to processes and systems for producing battery cans that provide superior battery performance.

### BACKGROUND OF THE INVENTION

Alkaline electrochemical cells and batteries are utilized in a wide variety of applications to provide either a main source of power or back-up power to a wide variety of devices. These cells employ an alkaline electrolyte solution combined with a zinc anode and a manganese dioxide cathode. The battery cans are fabricated from thin metal sheeting and are typically manufactured in cylindrical shapes in standard sizes such as AA, AAA, 4A, C, D, etc. for well-known applications such as toys, flashlights, portable audio devices, and the like.

In alkaline cells, the can itself serves as the cathode current collector. When incorporated into a circuit and used to provide a potential across a load, physical contact between the cathode and the can provides for the necessary electrical pathway for the cathodic cell reaction. An increase in the resistance of this contact causes a corresponding increase in the internal resistance of the cell, which in turn causes a decrease in the operational voltage and length of time over which the cell can be discharged. The resistance is oftentimes increased when the interior surfaces of the can exhibit a relatively smooth condition, thereby providing poor contact between the can and cathode and inhibiting the transfer of electrons across the can-to-cathode interface. On the other hand, as the resistance is minimized, as in the case of cells with roughened interior can surfaces, cell performance is improved.

Efforts have been made to enhance performance by providing roughened interior surfaces in the battery can. U.S. Pat. No. 6,087,040 issued Jul. 11, 2000, to Ohmura et al. discloses pre-plating a steel sheet with a nickel-cobalt or nickel-iron alloy and then using a D&I (drawing and ironing) or a DTR (drawing, thinning, and redrawing) process. U.S. Pat. No. 6,165,640 issued Dec. 26, 2000, to Sugikawa describes pre-plating a steel sheet with a nickel alloy on one side that is harder than a nickel alloy plated on the other side. The harder side is then used as the inside of the battery can in a subsequent D&I process to form the battery can. The roughness on the inner surface of the battery can is greater than that on the outer surface. Furthermore, U.S. Pat. No. 5,840,441 issued Nov. 24, 1998, also to Sugikawa pre-plates a very low carbon steel plate rolled in a special manner and anneals it after plating. Drawing and ironing operations are subsequently used to form the battery can. The foregoing patents require special plating alloys, special plating methods, or special rolling methods to achieve surface roughness on the interior of the battery can.

Another approach is described in U.S. Pat. No. 6,258,480 issued Jul. 10, 2001, to Moriwaki et al., which is applicable to an aluminum battery can produced by a D&I process. A multiplicity of shallow grooves are formed on the wide surface of a battery can by introducing hard particles such as alumina during the D&I processing.

Cell performance is also related to the amount of active materials disposed within the can. In order to increase the performance of an electrochemical cell, it is desirable to manufacture the cans with very thin walls in order to maximize the internal volume of the cells and allow more active materials to be incorporated into the cells. By increasing the amount of active materials in the cells, the performance of each cell is enhanced. To provide walls that are as thin as possible, either the cans are manufactured from a thinner stock or a thicker stock is thinned during the can forming operation.

Cans having thinner sidewalls are generally produced by a thinning operation involving either a drawing and thinning method or a drawing and ironing method. Although the methods are similar, there are fundamental differences in the properties of the products produced by these two methods.

In the drawing and thinning method, the walls of a battery can are stretched to yield a surface having a moderate-to-high roughness. However, beyond about a 20% reduction in the thickness of the wall, control of the wall thickness and its uniformity become difficult. Furthermore, in the drawing and thinning method, tool maintenance needed to maintain sidewall thickness tolerances becomes increasingly difficult as the degree of thinning increases, thereby increasing the costs associated with manufacturing the cans.

In the drawing and ironing method, excellent thickness control and uniformity of the walls can be achieved, and the costs associated with tooling maintenance are moderate. This is because the reduction in wall thickness is controlled as it takes place inside the ironing die. However, the drawing and ironing method produces surfaces that are very smooth and less suitable for use in alkaline battery cells.

Exemplary of the prior art related to the drawing and ironing method is U.S. Pat. No. 6,526,799 issued Mar. 4, 2003, to Ferraro et al., which patent is incorporated herein by reference. In that patent, a transfer process is employed to draw a cupped metal blank through a succession of drawing dies and then to iron the cylindrical casing in the final step, producing a battery can with a bottom thickness greater than its sidewall thickness.

Also exemplary of the prior art on drawing and ironing is U.S. Pat. No. 5,787,752 issued Aug. 4, 1998, in the name of Iwase et al. In that patent, a plated battery can with a bottom thickness greater than the sidewall thickness is produced by drawing and ironing simultaneously using a vertical stack of dies and a single punch, rather than a transfer process with multiple stations of dies and corresponding punches.

Also exemplary of the prior art on drawing and ironing is Japanese Laid-Open Patent Application No. 10-321198 published Dec. 4, 1998, in the applicant name Akira Kishimoto. In that application, a battery can with a bottom thickness greater than the sidewall thickness is made by drawing and ironing and then conducting a simple redrawing with clearance between the die and the punch that is equal to the sidewall thickness for the purpose of diameter reduction and formation of a stepped side flange. In the described simple redrawing, the punch will be in intimate contact with the sidewall of the can, resulting in a burnishing or smoothing effect on the inner surface of the sidewall.

What is needed is a process of producing battery cans having uniform and controlled walls that are as thin as possible so as to optimize the volumetric capacity of the cans and in which the interior surfaces of the walls are of suitable roughness to enable the cans to be utilized for alkaline cells.

### SUMMARY OF THE INVENTION

The present invention is directed to a process employing a transfer press for producing a battery can. In the preferred embodiment of the process, a metal blank is first cupped and then drawn through one or more die stations to form an elongated cylinder having an inner surface. The elongated cylinder is then processed through an ironing station followed by a final redraw station to re-roughen the inner surface. The embodiment of the transfer process comprises at least three independent die stations, namely, a first die station for drawing a cup into a cylinder having a wall with an inner wall surface, a second die station for ironing the wall of the cylinder to reduce the wall thickness, and a third die station for redrawing the cylinder into a battery can and re-roughening the interior surface of the can. The third punch and die station has a clearance greater than the thickness of the ironed wall of the previous step so as to achieve a surface roughness Ra of about 30 microinches to about 60 microinches. Additional die stations can be included ahead of the ironing station, as required, to achieve the desired diameter reduction of the can and additional ironing stations can be added to achieve greater wall thickness reductions. A battery can made by the process comprises a base and a wall extending from the base to define a cylinder with a sidewall thickness thinner than the base thickness, where the interior surface of the wall has a roughened surface to facilitate the transfer of electrons between the cathode and the can wall.

One advantage of the present invention is that moderate roughnesses of the inner surfaces of the battery cans can be attained. Such roughnesses are desirable in that they minimize the internal resistance of cells into which the cans are incorporated. The minimization of the internal resistance results in superior cell performance.

Another advantage is that an increased amount of control can be exercised over the manufacturing of the cans. In particular, the walls of the cans can be thinned to a high degree while maintaining close tolerances and uniformity of the sidewall thickness.

Still another advantage is that the maintenance associated with the tooling is minimized, thereby lowering manufacturing costs (as compared to other methods).

### BRIEF DESCRIPTION OF THE DRAWINGS

FIG. 1 is a simplified schematic diagram of a transfer press used for carrying out a draw-iron-redraw process for manufacturing battery cans.

FIG. 2 is a schematic perspective view of the tooling used in a typical station for drawing battery cans.

FIG. 3 is a schematic perspective view of the tooling used in a typical station for ironing drawn battery cans.

FIG. 4 is a schematic perspective view of the tooling used in a typical station for redrawing drawn and ironed battery cans.

FIGS. 5, 6 and 7 are enlarged cross-sectional views of battery cans resulting from the drawing, ironing and redrawing operations of FIGS. 2, 3 and 4, respectively.

### DETAILED DESCRIPTION OF THE PREFERED EMBODIMENT

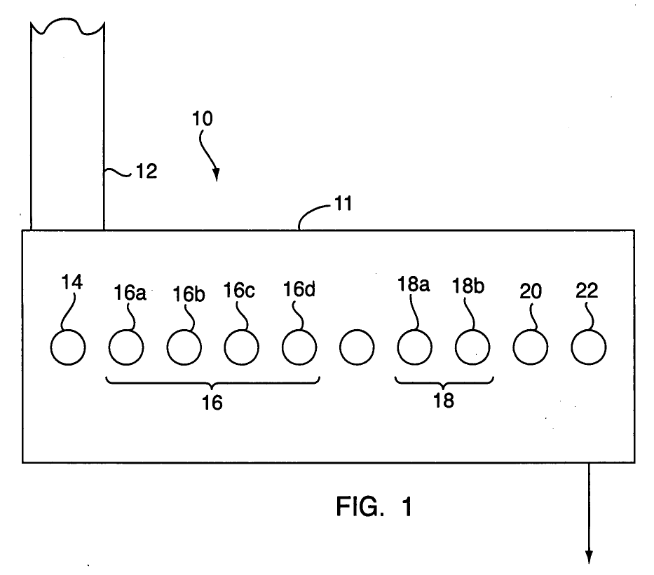

Referring to FIG. 1, a schematic diagram of the draw-iron-redraw manufacturing process in a transfer press is shown generally at 10 and is hereinafter referred to as “DIR process 10.” In the DIR process 10, cans are formed for use in battery cells as described above. Although the DIR process 10 as described below refers specifically to the forming of cans for alkaline battery cells, it should be understood that cans for other types of battery cells may be formed by the process described.

The DIR process is an improvement to a known transfer press process as described in the aforesaid U.S. Pat. No. 6,526,799. The DIR process is performed in a conventional transfer press 11, which may consist of multiple punch and die stations arranged inline, as depicted schematically in the drawing. Transfer press 11 is supplied with a strip of thin nickel plated steel 12. The feed mechanism is arranged to shift the strip from side to side to minimize scrap, using conventional feed mechanisms. An initial punch and die station 14 performs a blanking and cupping operation. The cup is transferred from station to station through transfer press 11 as the operations described in the DIR process 10 take place until the finished battery can is ejected from the final station.

The cup is transferred sequentially through several stations to perform the distinct operations to be described. The number of stations depends upon the degree of reduction in diameter and wall thickness that is desired in the finished battery can. The cooperative engagement of sequential punches and dies transforms the cup in a step-wise manner into an elongated right cylinder with a closed base having the final dimensions of a finished battery can. During the engagement of a punch and die, some heat is typically generated as the cup is forced through the die and this heat is removed by a suitable coolant system.

The cup is typically formed in a first station 14 of the transfer press 11, although the cup could be formed in a separate press and then transferred to transfer press 11. The cup is then transferred to the first drawing station at 16a and then to one or more subsequent drawing stations 16b, 16c, 16d, referred to collectively herein as drawing stations 16. Each successive die of each subsequent drawing station 16b, 16c, 16d has a diameter that is less than the diameter of the die in the preceding station. The transfer press 11 incorporates a number of such stations in series, which are actuated by a single stroke of the transfer press. Preferably, the thickness of the wall of the cup remains substantially the same as it progresses through the drawing stations 16, regardless of the number of drawing stations involved. The overall height of the cup, however, is significantly increased.

Following the initial drawing station or stations, the elongated cylinder is next transferred to an ironing station 18a, which comprises tooling similar to that of the drawing stations 16 except that the clearance between the punch and the die is less than the wall thickness of the incoming elongated cylinder. The ironing station functions to reduce the walls of the elongated cylinder to a uniform thickness. For large reductions in wall thickness, one or more additional ironing stations may be required, as shown at 18b, and referred to collectively herein as ironing stations 18, to effect the entire ironing process. After the ironing stations 18, the elongated cylinder is next transferred to a final redraw station 20.

The final redraw station 20 comprises a punch and die arrangement and causes the drawing of the cylinder to the final diameter of a finished battery can. Most importantly, in accordance with the present invention, the redraw station 20 converts the smooth inside surface of the ironed battery can into a roughened interior surface for enhanced electrical performance in the alkaline battery cell. In the final redraw station 20, the clearance between punch and die is greater than the thickness of the cylinder wall from the last ironing station 18b. This will cause roughening the previously smooth ironed surface of the can.

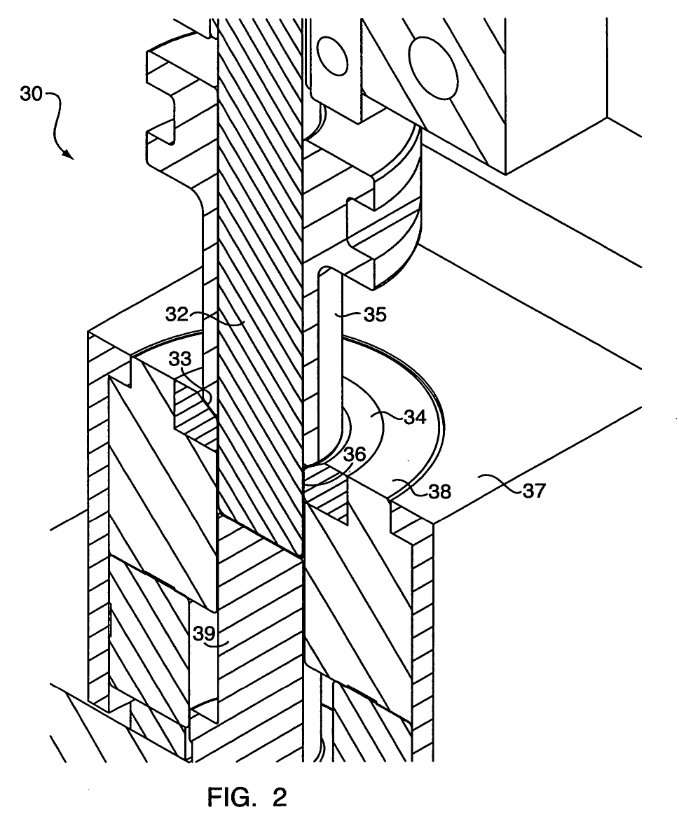

Finally, the finishing station 22 trims the excess material from the upper open end of the battery can, and ejects the can from the transfer press 11. The foregoing operations take place at very high speed. Detailed descriptions of the individual draw-iron-redraw (DIR) stations are described in the following, with reference to FIGS. 2, 3 and 4 respectively.

Referring now to FIG. 2, a first drawing station comprising the tooling in a typical station of the transfer press is shown generally at 30 and is hereinafter referred to as “drawing tooling 30.” The drawing tooling 30 comprises a drawing punch 32 and a drawing die 34 that cooperatively act on the cup, which is shown at 36. The drawing die 34 has a cylindrical cavity extending through its body, the cavity being defined by an inside wall of the drawing die 34. The drawing die 34 also has a beveled surface 33 at the mouth of the cavity that extends outwardly from the inside wall. A die holder 38, which is secured by a die shoe 37, is positioned to maintain the drawing die 34 (and thus the mouth of the cup 36) in a fixed position relative to the advance of the drawing punch 32. A sleeve 35 is inserted into the open end of cup 36, and the cup 36 is coaxially aligned with the mouth of the cavity of the drawing die 34. The drawing punch 32 is then advanced through the sleeve 35, contacted with an inner bottom surface of the cup 36, and further advanced into the drawing die 34, thereby drawing the material of the cup 36 into a clearance between the inside wall of the drawing die 34 and the outer surface of the drawing punch 32.

The force with which the drawing punch 32 is advanced into the cup 36 is such that, as the cup 36 is drawn into the drawing die 34, the material of the cup 36 may become heated. Furthermore, in drawing the material into the drawing die 34, the length of the cup 36 is increased while the diameter thereof is correspondingly reduced to result in an elongated right cylinder. Preferably, the thickness of the wall of the cup 36 remains substantially uniform and constant throughout the drawing process.

Upon completion of the cooperative action of the drawing punch 32 and the drawing die 34 on the cup 36, the sleeve 35 and the drawing punch 32 are retracted and a kickup pin 39 is advanced into the drawing die 34 from the opposite side from which the drawing punch 32 was advanced in order to push the cup 36 out of the open end of the drawing die 34.

In one exemplary embodiment of the invention, the elongated cylinder 36 ejected from the first drawing station 30 (FIG. 2) is transferred to a second drawing station (and optionally subsequent drawing stations) in which additional drawing operations are performed such that the diameter is further reduced and the length is further increased. In the subsequent drawing stations, the components thereof are substantially the same as those of the first drawing station tooling, except that the diameters of the drawing punches and the diameters of the cavities of the drawing dies are progressively reduced. In the additional drawing operations, the thickness of the wall of the elongated cylinder 36 is preferably not altered and remains substantially the same as the thickness of the bottom or base of the elongated cylinder 36.

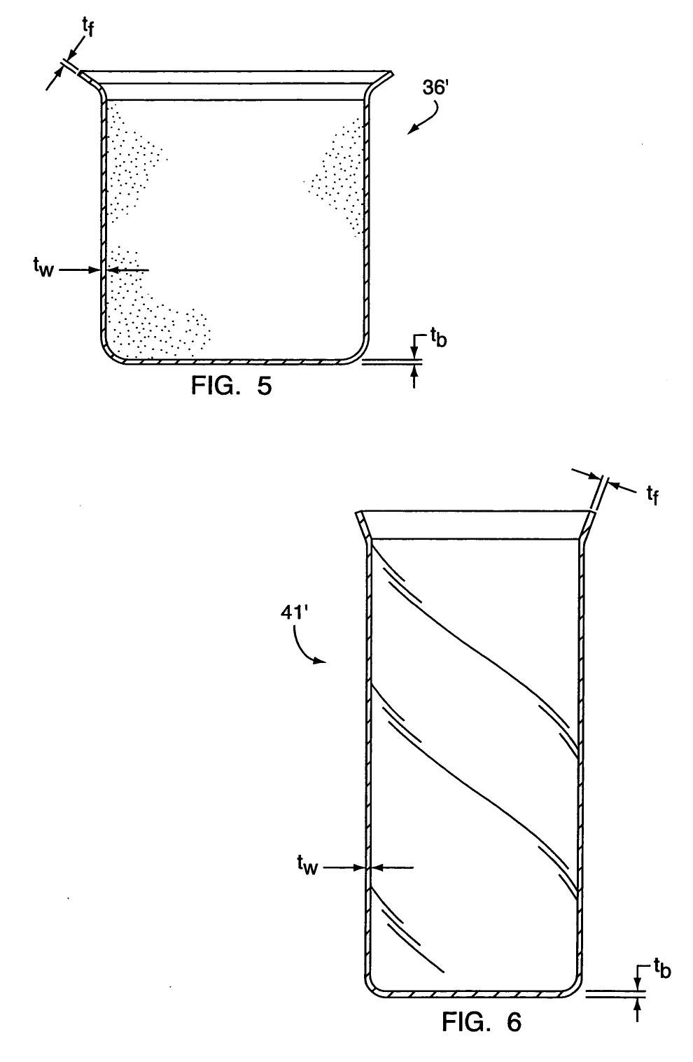

The elongated cylinder 36 shown in FIG. 2 is transformed by one or more drawing operations into an elongated cylinder 36′ seen in FIG. 5. Once drawn, the wall of the elongated cylinder 36′ has a thickness t_{w} that is substantially the same as a thickness t_{b} of the bottom or base of the elongated cylinder 36′, as can be seen in FIG. 5. It is especially preferred that the thickness of the wall of the elongated cylinder 36′ remains at least about 95% of the thickness of the bottom of the elongated cylinder 36′.

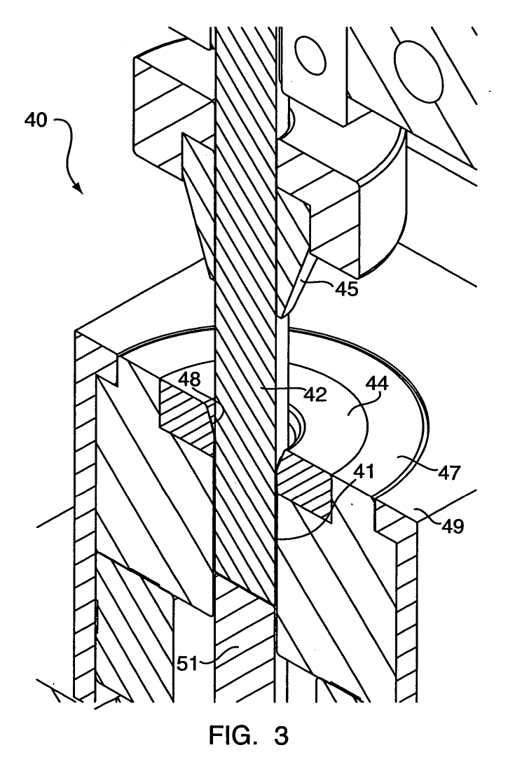

Referring now to FIG. 3, the tooling of the ironing station is shown generally at 40 and is hereinafter referred to as “ironing station tooling 40” that further transforms an elongated cylinder indicated by reference number 41. The ironing station tooling 40 comprises an ironing punch 42 and an ironing die 44 that cooperatively act on the drawn elongated cylinder 41. The ironing punch 42 is advanced through a stripper sleeve 45 that is coaxially aligned with an aperture in the ironing die 44 through which the ironing punch 42 forces the drawn elongated cylinder 41. The ironing die 44 is maintained in alignment with the ironing punch 42 via a die shoe 49. The mouth of the aperture of the ironing die 44 accepts the advancing ironing punch 42 and drawn elongated cylinder 41, and uniformly pinches or squeezes the walls of the drawn elongated cylinder 41 in a radial direction between a clearance formed by the die 44 and an outer surface of the ironing punch 42. The beveled surface 48 forms an angle with the outer surface of the ironing punch 42. The clearance between the die 44 and the outer surface of the ironing punch 42 is dimensioned to be less than the thickness of the wall of the drawn elongated cylinder 41 as received from the previous drawing station. Therefore, as the ironing punch 42 is advanced to force the drawn elongated cylinder 41 into the aperture of the ironing die 44, the clearance between the outer surface of the ironing punch 42 and the ironing die 44 is completely taken up by the material of the wall of the drawn elongated cylinder 41. Because the clearance is less than the thickness of the wall of the drawn elongated cylinder, as the drawn elongated cylinder 41 is advanced by the ironing punch 42, the ironing die 44 “irons” the material of the wall of the drawn elongated cylinder 41 to a substantially uniform thickness t_{w} that is less than the thickness t_{b} of the bottom of the elongated cylinder. This can be seen by reference to FIG. 6, where the drawn and ironed elongated cylinder is designated by reference number 41′. In a single ironing station, the thickness of the wall t_{w} can be reduced up to about 25%. However, by adding additional ironing stations in series, wall reductions up to 60% or more can be achieved. A thickness tf of the wall at the flange, however, preferably remains unaltered (substantially the same as the bottom thickness t_{b}). The ironing action of the material of the wall of the drawn and ironed elongated cylinder 41′ also changes some of the physical properties of the wall, particularly if the strip material from which the cup 36 is fabricated is cold-rolled nickel-plated steel. In particular, the ironing action increases the hardness of the steel in the region of ironing. Upon completion of the ironing process, the inner surface of the drawn and ironed elongated cylinder 41′ may be relatively smooth and have an Ra roughness of only about 20 microinches or less, as indicated by the shading of FIG. 6.

Referring again to FIG. 3, upon completion of the cooperative action of the ironing punch 42 and the ironing die 44 on the cylinder 41, the ironing punch 42 is retracted and a kickup pin 51 is advanced into the ironing die 44 from the opposite side from which the ironing punch 42 was advanced to push the cylinder 41 out of the open end of the ironing die 44.

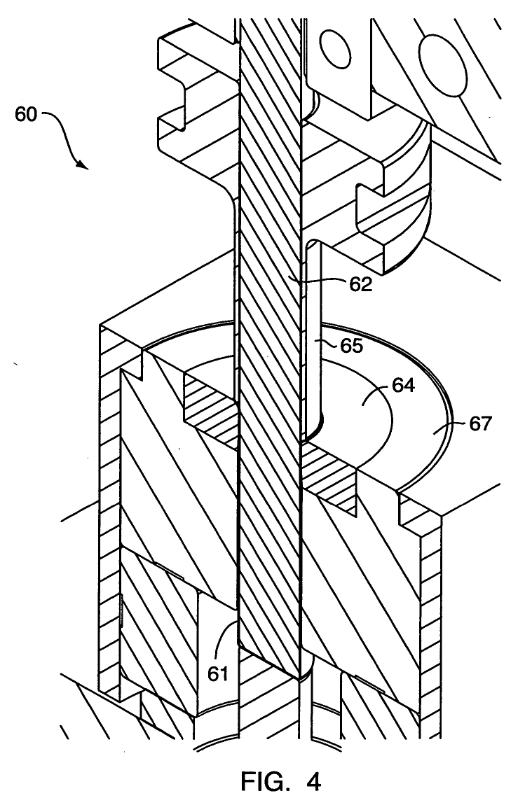

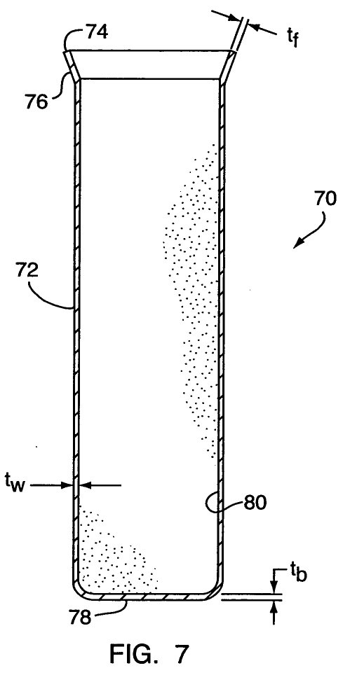

At least one ironing station is used in the process, but there may be more than one ironing station (see FIG. 1), depending on the amount of wall thickness reduction required. The resulting drawn and ironed elongated cylinder is designated by new reference number 61 in FIG. 4. Following the ironing process, the elongated cylinder 61 is fed to the final redraw station which comprises tooling that is substantially similar to the earlier drawing station tooling and is illustrated schematically in FIG. 4. The redraw tooling, which is shown generally at 60 and is hereinafter referred to as “redraw station tooling 60,” comprises a redraw punch 62 and a redraw die 64 that cooperatively act on the drawn and ironed elongated cylinder 61. In the operation of the redraw station tooling 60, the drawn and ironed elongated cylinder 61, which is now essentially a preformed battery can, is forced through a redraw die 64. Upon transfer of the drawn and ironed elongated cylinder 61 to the redraw station tooling 60 for the redraw, a sleeve 65 is inserted into the open end of the elongated cylinder 61, and the elongated cylinder 61 is coaxially aligned with the mouth of the cavity of the redraw die 64, the redraw die 64 being maintained in position by a die holder 67. The advancement of the redraw punch 62 through the sleeve 65 and into the elongated cylinder 61 and through the redraw die 64 redraws the elongated cylinder 61 into a clearance between an inner wall of the cavity of the redraw die 64 and the outer surface of the redraw punch 62. The clearance between the inner wall of redraw die 64 and the outer surface of the redraw punch 62 is carefully chosen so as to be greater than the thickness of the ironed wall of the elongated cylinder 61. The term “greater than” shall be construed to mean at least 0.0005 inches greater than the thickness of the ironed wall. The precise selection of the proper clearance is dependent upon many factors and can be determined by those skilled in the art. The resulting drawn, ironed, and redrawn elongated cylinder is then transferred to a final trimming station, resulting in a finished battery can 70, as shown in FIG. 7.

As the elongated cylinder 61 is redrawn through the redraw die 64, the inner surfaces of the elongated cylinder 61 are roughened by the redraw process to provide the suitable finishes thereon that facilitate contact and electron transfer to the cathode of an alkaline cell. The Ra roughness of the interior can surface is increased to at least 30 microinches, preferably about 35 microinches to about 45 microinches, and more preferably about 40 microinches to about 60 microinches.

Referring to FIG. 7, the thickness t_{w} of the wall of the battery can 70 is preferably not reduced in the redraw step. Furthermore, upon completion of the redrawing operation following the previous ironing process, the bottom or base of the battery can 70 will have a thickness t_{b} that remains substantially the same as the thickness of the starting metal sheet, and the flange will have a thickness t_{f} that remains substantially the same as the bottom thickness t_{b}.

The can 70 may be used for electrochemical cells, for example zinc/manganese dioxide alkaline cells or lithium/manganese dioxide cells, each having an outside diameter of about 7 millimeters (mm) to about 35 mm and a length of about 20 mm to about 60 mm. The can 70 is preferably constructed as a single-piece cylindrically-shaped body 72 having an open end and a closed end. A peripheral edge 74 is defined by the open end that may be outwardly stepped or flared to include an integrally-formed transition surface 76 that forms the lower portion of the peripheral edge 74. A bottom or base 78 defines the closed end and is integrally formed with the body 72. The body 72 has a wall thickness t_{w} that is less than the thickness t_{b} of the bottom 78 and less than the thickness t_{f} of the flange or peripheral edge 74. Preferably, the thickness t_{f} of the peripheral edge 74 is the same or greater than the thickness t_{b} of the bottom 78. In accordance with the present invention, an interior surface 80 of the body 72 has an average surface roughness Ra of at least 30 micro-inches and preferably 30 to 60 micro-inches as a result of the redrawing process in the final station.

The draw-iron-redraw (DIR) process disclosed above provides an improvement over prior art systems and methods for producing a battery can. In particular, the use of the disclosed drawing, ironing, and redrawing operations facilitates the working of the walls of the battery can to result in a can having defining surfaces that are thinned to uniform and well controlled thickness. Furthermore, thinning the defining surfaces to a high degree and to a uniform thickness followed by redrawing results in a can having internal surface characteristics that enhance the electrical performance of the cell into which the can is incorporated.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A process for producing a battery can, said process comprising:
blanking and forming a metal cup having a wall and a bottom,
drawing said cup in a first punch and die station to form an elongated cylinder having a wall,
ironing said elongated cylinder in a second punch and die station to form a drawn and ironed elongated cylinder having an ironed wall with an inner surface,
redrawing said drawn and ironed elongated cylinder in a third punch and die station having a clearance between punch and die greater than the thickness of said ironed wall so as to roughen said inner surface.

2. The process of claim 1, wherein said clearance is at least 0.0005 inches greater than the thickness of said ironed wall.

3. The process of claim 1, wherein said drawing said cup into an elongated cylinder further comprises drawing said elongated cylinder through a series of successive dies, each of said successive dies having a decreasing diameter.

4. The process of claim 1, wherein said ironing said elongated cylinder comprises ironing said elongated cylinder through a series of successive dies, each of said successive dies having a decreasing diameter.

5. The process of claim 1, wherein said drawing said cup comprises advancing a punch through a sleeve to draw said cup through a first die of said first die station so as to maintain a thickness of said wall of said cup at least about 95% of a thickness of said bottom of said cup.

6. The process of claim 1, wherein said ironing said elongated cylinder comprises advancing an ironing punch through an opening of an ironing die to force a wall of said elongated cylinder through a clearance formed by an outer surface of said ironing punch and said ironing die, wherein said clearance is dimensioned to be less than the thickness of said wall of said elongated cylinder.

7. The process of claim 1, wherein said redrawing said drawn and ironed elongated cylinder produces an average surface roughness Ra on said inner surface of said ironed wall of at least 30 microinches.

8. The process of claim 1, wherein said redrawing said drawn and ironed elongated cylinder produces an average surface roughness Ra on said inner surface of said ironed wall of about 30 microinches to about 60 microinches.

9. A process employing a transfer press for producing a battery can, said process comprising:
drawing a metal workpiece at a first transfer press station into a cylinder having a wall with an inner wall surface;
ironing said wall of said cylinder at a second transfer press station to provide an ironed wall; and
redrawing said cylinder into a battery can at a third transfer press station, said third transfer press station comprising a punch and die defining a clearance therebetween greater than the thickness of said ironed wall of said cylinder so as to roughen said inner wall surface.

10. The process of claim 9, wherein said clearance is at least 0.0005 inches greater than the thickness of said ironed wall

11. The process of claim 9, wherein said second transfer press station for ironing said wall of said cylinder comprises,
an ironing die having an opening to accept the incoming elongated cup, and
an ironing punch received through said opening of said ironing die so as to define a clearance between an outer surface of said ironing punch and the opening of said ironing die, said clearance being less than the thickness of the wall of said cylinder.

12. The process of claim 9, wherein said first transfer press station for drawing and said third transfer press station for redrawing each comprise;
a die having an opening with an inside wall,
a sleeve coaxially aligned and advanced to hold said cylinder in said die opening, and
a punch received through said sleeve so as to define a clearance between an outer surface of said punch and said inside wall of said die, said clearance at said third transfer press station being greater than the thickness of said wall of said cylinder when it enters said third transfer press station.

13. The process of claim 12, wherein said clearance at the third transfer press station is at least 0.0005 inches greater than the thickness of said wall of said cylinder when it enters the third transfer press station.

14. A battery can made by the process of claim 1, said battery can comprising:
a base; and
a wall disposed at said base, said wall extending from said base to define a cylinder open at an end of said wall opposite said base, and an interior surface of said wall having a roughened surface to facilitate electron transfer to and from said wall, and where said roughened surface has an average surface roughness Ra of at least 30 microinches.

15. A battery can according to claim 14, wherein said roughened surface has an average surface roughness Ra of about 30 microinches to about 60 microinches.

16. A battery can made by the process of claim 9, said battery can comprising:
a base; and
a wall disposed at said base, said wall extending from said base to define a cylinder open at an end of said wall opposite said base, and an interior surface of said wall having a roughened surface to facilitate electron transfer to and from said wall, and where said roughened surface has an average surface roughness Ra of at least 30 microinches.

17. A battery according to claim 16, wherein said roughened surface has an average surface roughness Ra of about 30 microinches to about 60 microinches.
